(19) United States
(12) Patent Application Publication
(10) Pub. No.: US 2025/0226681 A1
(43) Pub. Date: Jul. 10, 2025

(54) Method for Putting into Operation, Forming and Aging a Modular Battery Storage System

(71) Applicant: PULSETRAIN GMBH, Karlshuld (DE)

(72) Inventors: Manuel Kuder, München (DE); Michael Hohenegger, München (DE); Niclas Lehnert, Eggenfelden (DE); Lukas Obkircher, München (DE)

(21) Appl. No.: 18/854,441

(22) PCT Filed: Jul. 21, 2023
(86) PCT No.: PCT/EP2023/070291

§ 371 Date: Oct. 4, 2024

(30) Foreign Application Priority Data
Jul. 22, 2022 (DE) 10 2022 118 450.1

(51) Int. Cl. H02J 7/00; B60L 58/19

(52) U.S. Cl. CPC H02J 7/0069; B60L 58/19; H02J 2207/20; H02J 2310/48

(57) ABSTRACT

The invention relates to a method for putting at least one energy-storage module into operation, which energy-storage module is preferably intended for a vehicle and comprises a multilevel converter system, in which method multiple energy-storage modules and transistors are provided, wherein each energy-storage module can be connected in parallel with or connected in series with the adjacent energy-storage module and/or can bypass the adjacent energy-storage module and comprises at least one energy-storage cell, and the energy-storage modules, preferably the transistors, are connected in such a way that formation and/or aging is carried out during storage, transport to the vehicle and/or after installation in the vehicle.

The invention relates to a method for putting at least one energy-storage module preferably intended for a vehicle into operation.

Previous energy storage devices are usually loaded with DC voltage (DC). This is due to the structure of conventional converter systems. In this case, an attempt is made to keep the AC voltage components, i.e. harmonic oscillations, away from the energy storage devices.

Since many energy storage devices have to be connected in series or in parallel in this case, a battery management system (BMS) is required. A DC link capacitor may, e.g., be connected downstream of the energy storage devices. This serves to further smooth the three-phase currents of the converter and to keep high-frequency oscillations away from the energy storage devices and to intercept switching overshoots since the inductance of the energy storage devices would continue to drive the current. The aim of this procedure is to load the energy storage devices with DC since it is assumed in this case that this contributes to the durability of the battery cell and reduces the losses.

In a conventional electric vehicle for example, the converters which pass on the energy to the electric motor and deliver it to the battery again during braking energy recovery (recuperation) may be provided on the DC bus. Charging devices which can operate with alternating voltage (AC) or direct voltage (DC) can also be connected to this bus, for example.

These converters are in most cases in the form of two-point converters, e.g. in the form of a B6 bridge in the case of a three-phase design, or—especially in the field of solar installations—in the form of three-point converters.

As an alternative to bridge circuits as converters, so-called multilevel converter systems (MMC systems) are known.

Batteries, e.g. rechargeable batteries, can be used, for example, as energy storage devices or energy sources. In this case, the energy storage devices are not hard-wired to one another, but rather are combined as individual submodules. This structure is required for each phase. Therefore, the energy storage devices are divided among these phases and can be permanently connected in series or in parallel, for example.

The lithium-ion cells, as are used e.g. in electric vehicles, are charged for the first time after manufacture. In this case, the lithium ions are intercalated, i.e. embedded, into the anode. This forms the so-called SEI (Solid Electrolyte Interphase) layer and/or CIE (Cathode Electrolyte Interphase) layer.

A first discharging/charging cycle is then carried out and the cell can undergo so-called finishing.

First of all, so-called formation is carried out. Here, a plurality of charging and discharging operations of the cell are performed in particular sequences. The sequence in this case can vary depending on the manufacturer. Pulses can be applied to the energy-storage module during the formation for the purpose of diagnosis in order to establish whether said energy-storage module is defective or not.

After the formation, so-called aging is carried out. Here, the cells are stored for a number of weeks or months. This can for example also be done during the transport of the energy-storage module from Asia to Europe or to the USA.

The aging serves to detect cell-internal short circuits or other faults.

During the formation and/or aging, measurements, for example of the open-circuit voltage, can be carried out in order to determine the capacity as a function of time, for example. During the measurement processes, at least one discharging/charging cycle can be carried out as appropriate.

At the end of the aging, a charging operation is performed in order to establish a reference point.

If hardly any changes to the cell properties result over the time, the cell has a high quality.

The cells can thus be sorted according to their properties on the basis of the measurement data.

Subsequently, either cells with similar properties are installed together in a battery module or cells are combined in such a way that the battery modules have similar properties over-all, e.g. 48 volts.

The battery modules are then installed in the vehicle by the vehicle manufacturer.

Up until now, the formation and the aging have been performed by the battery manufacturer. The storage-related costs for the aging make up approximately 30% of the battery price in this case.

It is therefore an object of the invention to provide a method and an apparatus for putting at least one energy-storage module preferably intended for a vehicle into operation, in the case of which method/apparatus storage costs are reduced.

This object is achieved by the method and the apparatus of the independent claims.

According to the invention, the method is designed for putting at least one energy-storage module preferably intended for a vehicle, for example an electric vehicle, e.g. an electric passenger car, electric truck and/or electric bus, into operation or can be used for this purpose.

The energy-storage module can be a storage device of a preferably frequency-dependent electrical source, for example a battery, e.g. a rechargeable battery.

The method is implemented using a multilevel converter system, preferably a modular multilevel battery system (B2M), in which a multiplicity of energy-storage modules and transistors are provided.

A preferably modular multilevel converter system describes a way in which a plurality of energy-storage modules or transistors are arranged or connected.

Each energy-storage module can have at least one or exactly one battery, e.g. a rechargeable battery.

The transistors serve for example as switches which can be used, e.g., to select current and/or voltage paths. As a result, the energy-storage modules can be incorporated into or excluded from a desired configuration, for example.

At least or exactly two, three, four, five, six, seven, eight, nine, ten or more transistors are preferably assigned to each energy-storage module.

The transistor can be designed, for example, for a voltage of less than 500 V, 400 V, 300 V, 200 V, 100 V, 50 V, 40 V, 30 V, 20 V or 10 V. The transistor can preferably be designed for a voltage of between 2 V and 8 V, e.g. 3 V, 4 V, 5 V, 6 V or 7 V.

Each energy-storage module can be connected in parallel with the respectively adjacent energy-storage module and/or can be connected in series therewith and/or can be bypassed. Each energy-storage module can preferably be connected in series with the respectively adjacent energy-storage module. The possibility of connection in parallel is advantageous, but not necessary.

The adjacent energy-storage modules are preferably connected to one other via two current and/or voltage paths in each case. A transistor can be assigned to each path in this case.

For example, three transistors are provided between two adjacent energy-storage modules. The energy-storage modules can thus be connected, e.g., in parallel or in series.

Each energy-storage module has at least one energy-storage cell.

For example, the energy-storage module can have exactly one energy-storage cell. Preferably, however, each energy-storage module has a plurality of energy-storage cells, e.g. at least 10, 20, 30, 40, 50, 60, 70, 80, 90 or 100. For example, at least 100 energy-storage cells may be provided in an energy-storage module.

The energy-storage cells of an energy-storage module can preferably be connected to one another in parallel. Preferably, the energy-storage cells of an energy-storage module are selected in such a way that the same charge as that applied to the grid is applied, e.g. 230 V.

Multilevel converter systems are much more versatile than bridge circuits. This thus allows almost any configurations to be created. For example, the energy-storage modules can be connected to one other in any way, e.g. in parallel or in series. Individual energy-storage modules can also be incorporated into or excluded from a desired configuration.

The energy-storage modules, preferably the transistors, are connected in such a way that formation and/or aging is carried out during storage and/or transport to a vehicle and/or after installation in a vehicle. Preferably, the same multilevel converter system which is used during later operation can also be used for the formation and/or aging.

Without a multilevel converter system, this has not been possible up to now. The properties of the energy-storage modules thus have to be established namely first of all before said modules are installed in a vehicle in order to, for example, reject energy-storage modules or energy-storage cells which are defective or are of low quality beforehand, as appropriate.

It was surprising that this is not required in the case of a multilevel converter system. Energy-storage modules or energy-storage cells which are defective or are of low quality can thus also still subsequently—for example in a state installed in the vehicle—be bypassed or accordingly connected in order to achieve the desired overall capacity and/or to homogenize the aging. Optionally, achieving a lower overall capacity, which would likely entail a lower price for the energy-storage module, may also suffice.

Since the energy-storage module has to be transported from the battery manufacturer to the vehicle manufacturer anyway, this transport time can be used for the formation and/or the aging. Storage times and thus costs on the part of the battery manufacturer are thus minimized.

During the formation, the power electronics (here: multilevel converter system) can already be applied when the energy-storage modules are brought together and be used to carry out the charging and/or discharging patterns. The transport time can then be used for the aging. The testing can then likewise be performed by the multilevel converter system since this is able to carry out, e.g., electrochemical impedance spectroscopy (EIS) and by way of this to diagnose changes in the cells and/or to collect data.

Since in the case of this method the energy-storage modules are not yet installed in the vehicle, two energy-storage modules can, for example, be connected to one another and current can be charged from one module into another. In this case, one module is charged and the other is discharged in alternation until the formation is completed.

Alternatively or in addition, the formation and/or the aging of the energy-storage module can be carried out after installation in the vehicle, for example during the storage before delivery to the customer or during the transport of the vehicle to the customer. Furthermore, it is conceivable for the vehicle to already be delivered to the customer and for the aging to be performed during operation within the first weeks or months.

The testing can also take place here via the multilevel converter system since this is able to, e.g., carry out EIS and by way of this to diagnose changes in the cells.

Since the energy-storage modules are already installed in the vehicle, it is no longer possible to connect the energy-storage modules to one another in order to then charge and/or discharge them.

It is conceivable to carry out the formation until the optimum state of charge (SoC) has been achieved in order to transport the vehicle to the customer or to store the vehicle.

The method according to the invention thus allows costs to be reduced when putting at least one energy-storage module intended for a vehicle into operation since unnecessary storage times for the formation and/or the aging are done away with.

The manufacturing process of energy-storage modules can fundamentally change by virtue of the method according to the invention.

As a result of the fact that various sub-steps of the manufacturing process are transferred from the factory to the respective end product, the manufacturing costs can be significantly reduced, e.g. by at least 18%.

This is also due to the fact that the power electronics can engage directly with each energy-storage module. The aging for each energy-storage module can thus be carried out individually.

Since the properties of the energy-storage modules do not have to be acquired before the installation in the vehicle, the aging can take place during the transport and/or during the production of the vehicle. As a result, it is no longer necessary for exclusively identical energy-storage modules to be installed in a battery pack.

Developments of the invention can also be gathered from the dependent claims, the description and the accompanying drawings.

According to one embodiment, each energy-storage module has a multiplicity of energy-storage cells.

For example, an energy-storage module can have exactly or at least 10, 20, 30, 40, 50, 60, 70, 80, 90 or 100 energy-storage cells.

According to a further embodiment, a plurality of charging and discharging operations are carried out during the formation and/or aging.

The terms charging operation and discharging operation are to be understood broadly and encompass partial charging and partial discharging as well as complete charging and discharging operations.

A multilevel converter system also, for example, allows direct heating of at least one energy-storage module by way of a corresponding circuit.

This may be useful, for example, if the formation and/or aging is carried out during storage, transport to the vehicle and/or after installation in the vehicle and the outside temperatures are low in this case.

The energy-storage module can thus practically itself generate the heat required for the formation and/or aging.

According to a further embodiment, at least two energy-storage modules or energy-storage-module systems are connected to one another and charge and/or discharge one another.

The formation and/or aging can thus be performed by the energy-storage modules themselves.

This is possible, for example, if the energy-storage modules or the energy-storage-module system are/is not yet installed in the vehicle.

An energy-storage-module system can, for example, comprise all of the energy-storage modules for a vehicle.

According to a further embodiment, the energy-storage module is charged and/or discharged by means of a charging device and/or a motor of the vehicle.

This is possible, for example, if the energy-storage module is not yet installed in the vehicle. This is likewise possible if the energy-storage module is already installed in the vehicle.

Also conceivable is a combination in which a further energy-storage module, a charging device and/or a motor of the vehicle is/are reverted to for charging and/or discharging depending on the requirements for the formation and/or aging.

The charging device can, for example, be an external charging apparatus, e.g. a charging column or wallbox, which can be connected, e.g., to the power grid.

An external charging device may be necessary, for example, in order to compensate for (heat) losses.

For example, the wallbox of the end customer can be used as the charging device. In this case, the customer only knows how good the energy-storage modules or the energy-storage-module system in their vehicle are/is, i.e. how much capacity they/it have/has, after a few weeks or months. The formation and/or aging is carried out only by the customer in this case.

It is additionally conceivable for the energy-storage module to be charged and/or discharged by means of the motor of the vehicle. In this case, the multilevel converter system can preferably allow fully automated formation to be performed without electrical connection to the outside world. This is possible, for example, if no heating is required and only pulses have to be generated.

According to a further embodiment, different pulses are applied to the energy-storage modules during the formation and/or aging.

For example, the duration and/or current strength of the pulses can vary.

The pulses can be generated, e.g., by connecting the energy-storage modules in parallel and/or by reversing the poles and subsequently placing the poles back into the starting situation.

For example, it is possible to charge and/or discharge from one converter arm or converter strand into the other such that fewer losses occur. In contrast to the actual use, a constant voltage can be generated by two converter strands, i.e. two strands have the same voltages. As a result, control is greatly simplified.

Alternatively, two energy-storage modules may also be connected in parallel. Or a voltage of, for example, 200 V is set at two energy-storage modules and a voltage of 180 V is set at another energy-storage module. Current can thus flow from the two 200 V energy-storage modules into the 180 V energy-storage module. As a result, a current flow can likewise be generated, for example via the motor. This current flow is set by varying the strand voltages in such a way that the battery formation is carried out. A pulse-shaped loading can be applied directly to the energy-storage modules by way of the respective switches.

A master controller can set the overall current flow in this case and the respective slave modules draw the correct pulses therefrom by being connected in series, in parallel or being bypassed.

Meanwhile, the energy-storage modules could preferably already be monitored by means of a sensor system.

The pulses can, e.g., be used for the diagnosis in order to determine the quality of the energy-storage modules.

According to a further embodiment, data of the energy-storage modules are ascertained before, during and/or after the formation and/or aging.

Data can thus preferably be acquired continuously.

Data can be ascertained from tests before, during and/or after charging and discharging operations. For example, EIS can be carried out.

The procedure for the formation of energy-storage modules or energy-storage cells differs greatly depending on the manufacturer, but energy-storage modules or energy-storage cells of one manufacturer also differ greatly from one another due to different cathode materials, anode materials and electrolytes. In addition, however, the formation can also differ in the case of energy-storage modules or energy-storage cells of the same construction type and manufacturer.

The underlying process is the same for all energy-storage modules, however.

In the case of EIS, the x-axis shows the real part of the impedance (complex resistance) of the energy-storage module and represents the actual losses of the energy-storage module at this operating point. The y-axis shows the imaginary part of the impedance at the operating points.

The different operating points come about due to different applied voltage frequencies.

The frequencies in the upper right corner are thus low and strongly influenced by the diffusion. The losses in the lower left are the losses at high frequencies and strongly influenced by the inductive behavior.

Each system that is to be examined can basically be understood to be a combination of resistors, capacitors and/or inductors, which correspond to certain real components or operations. Exact knowledge of the system makes it possible to create an equivalent circuit diagram. Changes in the electrical behavior can therefore be interpreted as changes in individual system components.

For the purpose of characterization, a current pulse can, e.g., be connected or applied to the energy-storage module and the resulting voltage response measured. The frequency can, for example, be 2.5 kHz.

A resonant circuit which sends energy back and forth between two energy-storage modules can, for example, also be provided.

Preferably, an individual loading profile can be created for each energy-storage module, which loading profile can preferably be adapted during operation.

According to a further embodiment, a digital image of the energy-storage module is created from the data.

The digital image can, for example, be created while at a standstill and/or during the first journey. The energy-storage modules can in further course be loaded such that the state of aging and/or the properties are adjusted by different loading profiles.

The digital image can be continuously adapted to the presently ascertained data.

Preferably, artificial intelligence (AI) can be used. For example, the AI can learn which pulses are optimal. This could also still be readjusted later by the vehicle manufacturer as appropriate.

With the help of AI, the formation could, for example, also be constantly modified a little in order to determine, over the course of the life of the energy-storage module, whether the changes have made a difference. The production could thus be improved step by step.

According to a further embodiment, the energy-storage modules are connected during operation of the vehicle depending on the data ascertained during the formation and/or aging.

Conventional cell matching is preferably not required.

The multilevel converter system makes it possible to constantly remeasure the energy-storage modules during operation and/or match them to one another. Defective energy-storage modules can, for example, also be bypassed.

In contrast to conventional systems, the worst energy-storage module thus does not determine the overall power since it can be bypassed.

For example, the price of the vehicle may depend on the energy of the energy-storage modules, e.g. depending on kWh. Furthermore, it is conceivable for the end customer to receive compensation or a bonus, for example, in the case of energy-storage modules of low quality. This can also take place later and/or during charging. The charging column can thus, for example, detect how good the installed energy-storage modules are, and, e.g., adapt the price per kWh thereto. Especially from an environmental point of view, it is advantageous if even energy-storage modules with low capacity are used, even if the maximum range drops as a result. End customers who use a corresponding vehicle with a lower range can receive, e.g., a bonus and/or a reward.

Finally, the invention relates to an apparatus for putting at least one energy-storage module preferably intended for a vehicle into operation.

The apparatus has a multilevel converter system with a multiplicity of energy-storage modules and transistors, wherein each energy-storage module is able to be connected in parallel with the respectively adjacent energy-storage module, is able to be connected in series therewith and/or is able to be bypassed, and has at least one energy-storage cell.

Furthermore, the multilevel converter system comprises a control apparatus which is designed to connect the energy-storage modules, preferably the transistors, in such a way that formation and/or aging are/is carried out during storage, transport to a vehicle and/or after installation in a vehicle.

All embodiments and components of the apparatus which are described here are preferably designed to be operated in accordance with the method described here, e.g. by means of the control apparatus. Furthermore, all embodiments of the apparatus which are described here and all embodiments of the method which are described here can be respectively combined with one another, preferably also dissociated from the specific configuration in the context of which they are mentioned.

The invention is described by way of example below with reference to the drawings, in which:

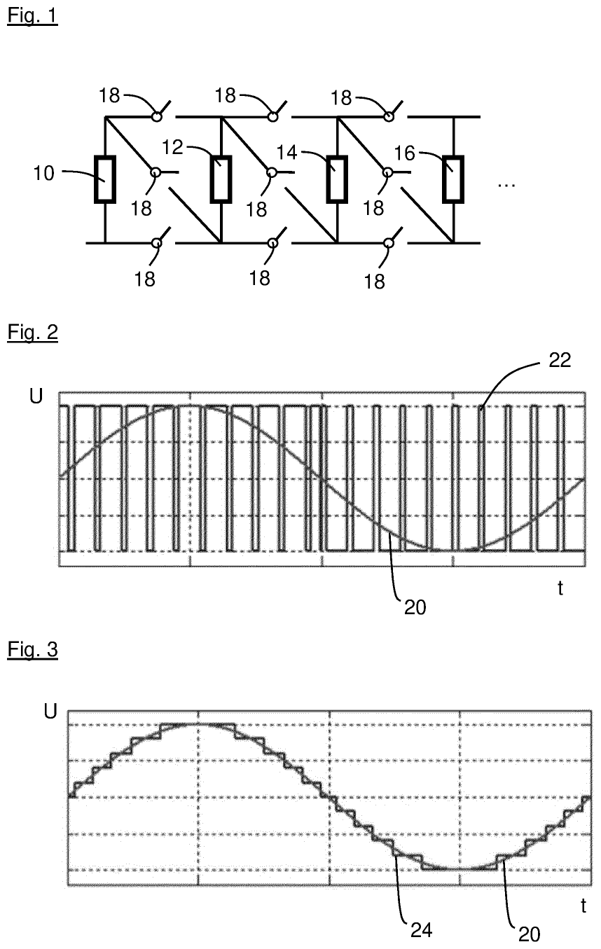

FIG. 1 shows one embodiment of an MMC system according to the invention,

FIG. 2 shows a profile of the output voltage of a PWM system according to the prior art,

FIG. 3 shows a profile of the output voltage of one embodiment of an MMC system according to the invention,

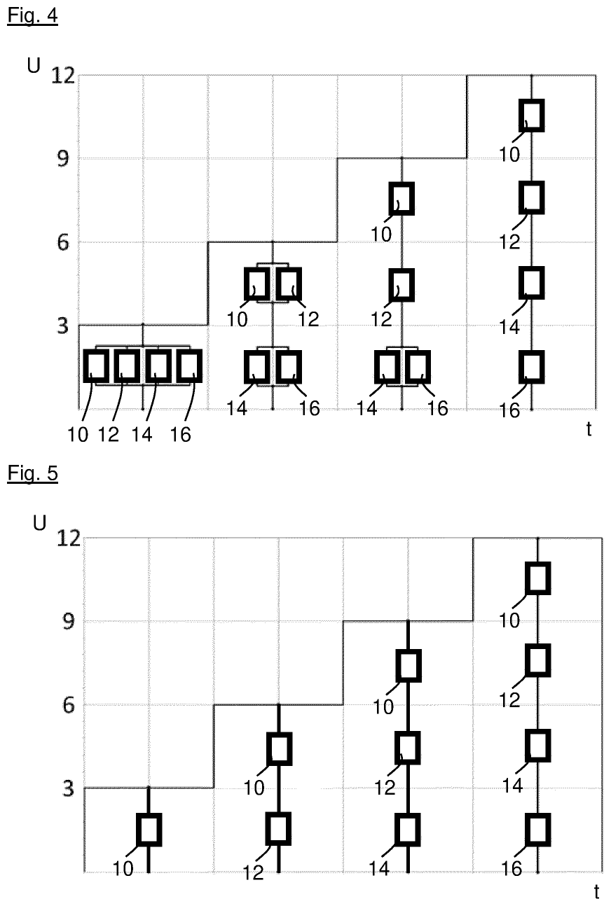

FIG. 4 shows a power (loss)-optimized configuration of an MMC system according to the prior art with parallel connection,

FIG. 5 shows a configuration of one embodiment of an MMC system according to the invention for the formation and/or aging of energy-storage modules without parallel connection,

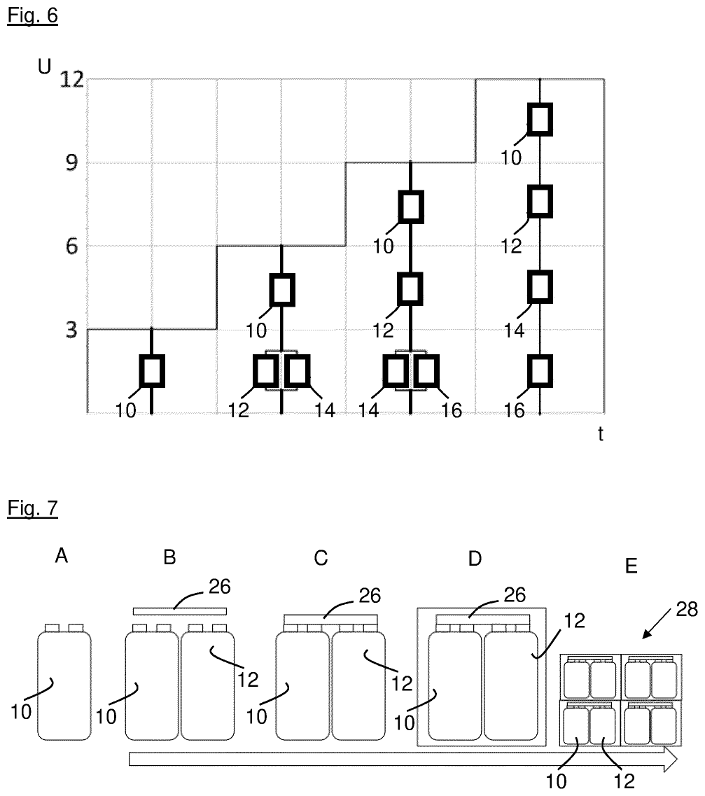

FIG. 6 shows a configuration of a further embodiment of an MMC system according to the invention for the formation and/or aging of energy-storage modules,

FIG. 7 shows a schematic illustration of one embodiment of a method according to the invention, and

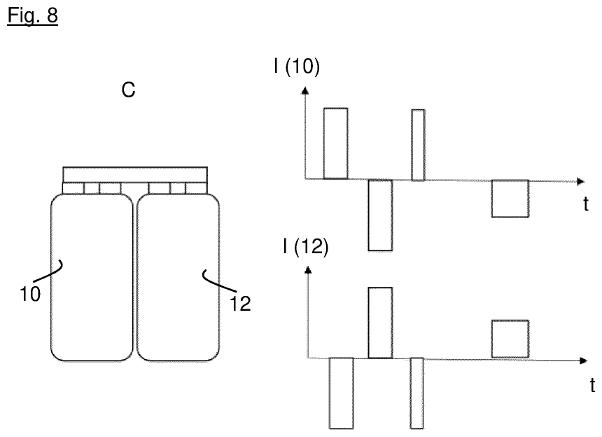

FIG. 8 shows a schematic illustration of a pulse distribution of the method according to the invention.

First of all, it should be noted that the embodiments illustrated are of a purely exemplary nature. Thus, individual features can be implemented not only in the combination shown, but also alone or in other technically useful combinations. For example, the features of one embodiment can be combined in any desired manner with features of another embodiment. The configuration and/or number of energy storage modules, paths and transistors shown is/are purely exemplary and basically arbitrary.

If a figure contains a reference sign that is not explained in the directly related text of the description, reference is made to the corresponding preceding or subsequent comments in the description of the figures. The same reference signs are thus used for identical or comparable components in the figures and are not explained again.

FIG. 1 shows a multilevel converter system for the formation and/or aging of energy-storage modules of at least one energy-storage module 10, 12, 14, 16.

Adjacent energy-storage modules 10, 12, 14, 16 are each connected to one another via a plurality of paths.

A switch in the form of a transistor 18 is provided in each path.

The adjacent energy-storage modules 10, 12, 14, 16 can thus be connected to one another in series or in parallel. Individual energy-storage modules 10, 12, 14, 16 can also be bypassed as appropriate, e.g. by closing the upper switch 18, and can be excluded from a configuration in this way.

FIG. 2 illustrates the voltage profile U of a PWM modulation over time t.

For a three-phase DC/AC system coupling, six switches are required in this case.

In the case of a B6 bridge or a two-point converter, the DC voltage is switched on synchronously via one or more switches such that only an AC voltage is set on average over time.

The sinusoidal target voltage 20 is therefore only rudimentarily recreated by the output voltage 22 of the PWM system.

FIG. 3 shows the voltage profile U of an MMC system in volts over time t in seconds.

The sinusoidal target voltage 20 is replicated by the structure of individual steps 24. The output voltage 24 therefore replicates the sinusoidal target voltage 20 much better.

FIG. 4 shows a power (loss)-optimized configuration of an MMC system. The voltage U is illustrated in volts over time t in seconds.

It is shown, by way of example, how the first three voltage stages can be formed by a parallel connection of the energy-storage modules 10, 12, 14, 16. The connection is in principle able to be extended to any number of energy-storage modules.

In order to optimize the power and to obtain the best efficiency, all of the energy-storage modules 10, 12, 14, 16 are always incorporated into the configuration in each stage.

FIG. 5, on the contrary, shows a configuration in which all of the energy-storage modules 10, 12, 14, 16 are connected in series.

FIG. 6 illustrates another exemplary configuration.

In the first stage, the energy-storage module 10 is on its own and in the further steps it is connected in series with at least one of the other energy-storage modules 12, 14, 16.

The configurations shown by way of example in FIGS. 4 to 6 can be used for the formation and/or aging of the energy-storage modules 10, 12, 14, 16.

Different pulses can be generated depending on the configuration. The quality of the individual energy-storage modules 10, 12, 14, 16 can be determined in this case by measurements.

The energy-storage modules 10, 12, 14, 16 can then be arranged in a suitable configuration in accordance with their quality.

In the example illustrated in FIG. 5, the energy-storage module 10 is incorporated into the configuration on its own in the first stage and is connected in series with a further energy-storage module 12 in the second stage, connected in series with two further energy-storage modules 12, 14 in the third stage and connected in series with three further energy-storage modules 12, 14, 16 in the fourth stage.

The energy-storage module 10 may, e.g., have a high quality and therefore always be incorporated. The energy-storage module 16 may, on the contrary, be of low quality, which is why it is hardly used.

In FIG. 6, in the first stage the energy-storage module 10 is on its own and in the further stages it is connected in series with at least one of the other energy-storage modules 12, 14, 16.

The configuration shown in FIG. 6 may illustrate an optimized configuration in which the losses for one or more energy-storage modules 10, 12, 14, 16 are low.

The configurations illustrated in FIGS. 5 and 6 are purely exemplary. Other configurations are likewise conceivable depending on the quality of the energy-storage modules 10, 12, 14, 16.

FIG. 7 shows a possible method for putting at least one energy-storage module 10, 12 intended for a vehicle into operation.

In step A, an energy-storage module 10 is produced.

In steps B and C, the energy-storage module 10 is connected to an energy-storage module 12 via a circuit board 26 on which an MMC system is arranged.

Once the energy-storage modules 10, 12 are connected, the formation can be carried out. Subsequently, in step D, the aging takes place. This can, for example, take place during the transport to the vehicle manufacturer.

The energy-storage modules 10, 12 can, for example, be combined to form an energy-storage-module system 28 illustrated in step E and be installed in a vehicle.

In the vehicle itself, the individual energy-storage modules 10, 12 can be loaded depending on their quality.

The quality of the energy-storage modules 10, 12 can also be ascertained during operation. A new configuration can thus be selected if the quality of the energy-storage modules 10, 12 changes.

The data obtained during the formation and/or aging for characterizing the energy-storage modules 10, 12 can, for example, be used for the next production of energy-storage modules.

FIG. 8 shows step C, i.e. the formation.

For an MMC in the form of a three-point converter, different pulses can be generated.

The current strength I (in amperes) can thus vary over time t (in seconds). For example, the strength and/or duration of the pulses may change.

Preferably, the current strengths of the pulses of the energy-storage module 10 behave inversely to the current strengths of the pulses of the energy-storage module 12.

### LIST OF REFERENCE SIGNS

10, 12, 14, 16 Energy-storage module
18 Transistor
20 Target voltage
22 Output voltage PWM system
24 Stage, output voltage MMC system
26 Circuit board
28 Energy-storage-module system
A-E Method steps
I Current strength
t Time

1. A method for putting at least one energy-storage module (10, 12, 14, 16) into operation using a multilevel converter system, in which method
a multiplicity of energy-storage modules (10, 12, 14, 16) and transistors (18) are provided, wherein each energy-storage module (10, 12, 14, 16) can be connected in parallel with the respectively adjacent energy-storage module (10, 12, 14, 16), can be connected in series therewith and/or can be bypassed, and has at least one energy-storage cell, and
the energy-storage modules (10, 12, 14, 16), are connected in such a way that formation and/or aging are/is carried out during storage, transport to a vehicle and/or after installation in a vehicle.

2. The method as claimed in claim 1, wherein each energy-storage module (10, 12, 14, 16) has a multiplicity of energy-storage cells.

3. The method as claimed in claim 1, wherein a plurality of charging and discharging operations are carried out during the formation and/or aging.

4. The method as claimed in claim 1, wherein at least two energy-storage modules (10, 12, 14, 16) or energy-storage-module systems (28) are connected to one another and charge and/or discharge one another.

5. The method as claimed in claim 1, wherein the energy-storage module (10, 12, 14, 16) is charged and/or discharged by means of a charging device and/or a motor of the vehicle.

6. The method as claimed in claim 1, wherein different pulses are applied to the energy-storage modules (10, 12, 14, 16) during the formation and/or aging.

7. The method as claimed in claim 1, wherein data of the energy-storage modules (10, 12, 14, 16) are ascertained before, during and/or after the formation and/or aging.

8. The method as claimed in claim 7, wherein a digital image of the energy-storage module (10, 12, 14, 16) is created from the data.

9. The method as claimed in claim 7, wherein the energy-storage modules (10, 12, 14, 16) are connected during operation of the vehicle depending on the data ascertained during the formation and/or aging.

10. An apparatus for putting at least one energy-storage module (10, 12, 14, 16) into operation, having
a multilevel converter system with
a multiplicity of energy-storage modules (10, 12, 14, 16) and transistors (18), wherein each energy-storage module (10, 12, 14, 16) is able to be connected in parallel with the respectively adjacent energy-storage module (10, 12, 14, 16), is able to be connected in series therewith and/or is able to be bypassed, and has at least one energy-storage cell, and
a control apparatus which is designed
to connect the energy-storage modules (10, 12, 14, 16), in such a way that
formation and/or aging are/is carried out during storage, transport to a vehicle and/or after installation in a vehicle.
